(19) United States
(12) Patent Application Publication
(10) Pub. No.: US 2007/0010301 A1
(43) Pub. Date: Jan. 11, 2007

(54) Portable terminal with slide keypad for convenient data input

(75) Inventor: Young S. Kim, Los Altos, CA (US)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/481,529

(22) Filed: Jul. 6, 2006

(30) Foreign Application Priority Data
Jul. 6, 2005 (KR) 60797-2005

(51) Int. Cl. H04M 1/00

(52) U.S. Cl. 455/575.5

(57) ABSTRACT

Disclosed is a portable terminal including a slide keypad for conveniently inputting data. The portable terminal includes a body, a display unit connected to the body through a swivel hinge unit to open/close an upper surface of the body or to be located parallel to the body along the lengthwise direction of the body, a fixed keypad installed in the body and a movable keypad moved so as to be close to or far away from the fixed keypad with the movable keypad facing the fixed key pad, moved with the movable keypad facing the body, and opened or closed by the rotation of the display unit or by self-movement. The movable keypad slides to be used even when the body is closed by the display unit, or the fixed keypad and the movable keypad are used together by the rotation of the display unit.

### PRIORITY

This application claims priority to an application entitled “PORTABLE TERMINAL INCLUDING SLIDE KEYPAD FOR CONVENIENTLY INPUTTING DATA” filed with the Korean Intellectual Property Office on Jul. 6, 2005 and assigned Serial No. 2005-60797, the contents of which are incorporated herein by reference.

### BACKGROUND OF THE INVENTION

1. Field of the Invention

The present invention relates to a portable terminal including a cellular phone, a PDA (Personal Digital Assistants), an HHP (Hand Held Phone), a DMB (Digital Media Broadcast) phone, a camera phone, a chatting phone, and the like, and more particularly to a portable terminal including a slide keypad for conveniently inputting data.

2. Description of the Related Art

In general, a “portable communication device” refers to an electronic device that a user can carry to perform wireless communication with a desired partner. To facilitate portability, designs of such portable communication devices tend not only to be compact, slim, and light, but are also moving toward providing increasing multimedia capability and a wider variety of functions. In particular, future portable communication devices are expected to incorporate greater multi-functionality and multi-purpose utility, as well as being more compact and lightweight, and having the capability of modification to suit various multimedia or Internet environments. Additionally, portable communication devices are now commonly used by people of all ages and all walks of life throughout the world, and are recognized by some people as a nearly indispensable commodity.

Portable communication devices may be classified into various categories according to their appearance, such as a bar-type portable communication device, a flip-type portable communication device and a folder-type portable communication device. A bar-type portable communication device refers to a device having a single housing of a bar-shape. A flip-type portable communication device refers to a device in which a flip is rotatably mounted to a housing by a hinge unit. A folder-type communication device refers to the manner in which a folder is rotatably connected to a single bar-type housing by a hinge unit.

Portable communication devices may also be classified into a necklace-type portable communication device and a bracelet-type portable communication device according to the wearing position or the manner in which users wear the portable communication devices. The necklace-type portable communication device refers to a portable manner in which a terminal is worn around a neck of a user by using a string. Further, the bracelet-type portable communication device refers to a portable manner in which a terminal is worn around a wrist of a user.

In addition, portable communication devices may be classified into a rotation-type portable communication device and a slide-type communication device according to the manner in which the portable communication device is opened and closed. The rotation-type portable communication device refers to a manner in which two housings are rotatably connected, opposed to each other. The slide-type communication device refers to a manner in which two housings slide with respect to each other in the lengthwise direction of the device. These variously classified portable communication devices can be easily understood by those skilled in the art.

Meanwhile, conventional portable communication devices now tend to transmit data at a high speed in addition to performing the basic voice communication function. In other words, according to the increase in consumer demand, portable communication devices now tend to provide a service using a wireless communication technology capable of transmitting data at high speed.

Recent portable communication devices also tend to be equipped with a camera lens to obtain video signals for transmission. Particularly, current portable communication devices have an external or embedded camera lens module which enables users to perform video communication with desired partners or to photograph desired subjects.

However, although a swing-type portable terminal has a structure in which a swing housing is swung from the body to open the upper surface of the body, the keypad disposed on the body cannot be used if the swing housing is closed and the keypad can be used only after the swing housing is swung from the body. The above keypad not only refers to simple volume keys, talking buttons, and direction keys, but also refers to an at least 3×4 keypad for inputting numbers and letters, all of which are difficult to operate.

According to a conventional folder-type portable terminal, the keypad disposed on the body cannot be used if the folder is closed and a user should open the folder from the body to use the keypad.

Further, the conventional portable terminal is inconvenient for inputting complex letters and numbers. In addition, only one hand is generally used in order to input complex letters in a chatting mode or the like.

### SUMMARY OF THE INVENTION

Accordingly, the present invention has been made to solve the above-mentioned problems occurring in the prior art, and an object of the present invention is to provide a portable terminal capable of inputting data conveniently in a selected mode by including a slide keypad having at least 3×4 keys.

It is another object of the present invention to provide a portable terminal capable of inputting letters conveniently in letter input mode by providing the QWERTY key arrangement.

It is still another object of the present invention to provide a portable terminal capable of inputting data conveniently by providing a keypad which can slide even in a closed state.

It is yet another object of the present invention to provide a portable terminal capable of inputting letters and confirming the inputted letters conveniently by providing a fixed keypad, a movable keypad and a display unit which can be operated in the landscape mode.

In order to accomplish these objects, there is provided a portable terminal that includes a body, a display unit connected to the body through a swivel hinge unit to open/close an upper surface of the body or to be located in parallel to the body along the lengthwise direction of the body, a fixed keypad installed in the body and a movable keypad moved so as to be close to or far away from the fixed keypad with the movable keypad facing the fixed key pad, moved with the movable keypad facing the body and opened or closed by the rotation of the display unit or the self-movement. The movable keypad slides to be used even when the body is closed by the display unit, or the fixed keypad and the movable keypad are used together by the rotation of the display unit.

In order to accomplish these objects, there is also provided a portable terminal that includes a body, a folder connected to the body through a hinge unit to be folded or unfolded and a slide keypad slidably movable with the slide keypad facing the body continuously for opening or closing an upper surface thereof according to the rotation of the folder or the self-movement, wherein the slide keypad can be in a usable state by the slide thereof even when the folder is closed or by the rotation of the folder.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view of a portable terminal according to the first preferred embodiment of the present invention;

FIG. 2 is a front view of a portable terminal according to the first preferred embodiment of the present invention with a slide key pad thereof slid;

FIG. 3 is a perspective view of a portable terminal according to the first preferred embodiment of the present invention with a swing housing being swung;

FIG. 4 is a perspective view of a portable terminal according to the first preferred embodiment of the present invention with a swing housing thereof completely swung;

FIG. 5 is a perspective view of a portable terminal according to the first preferred embodiment of the present invention with a swing housing thereof installed so as to be inclined after being completely swung;

FIG. 6 is a perspective view of a portable terminal according to the second preferred embodiment of the present invention;

FIG. 7 is a perspective view of a portable terminal according to the second preferred embodiment of the present invention with a slide keypad thereof slid; and

FIG. 8 is a perspective view of a portable terminal according to the second preferred embodiment of the present invention with a folder thereof being rotated.

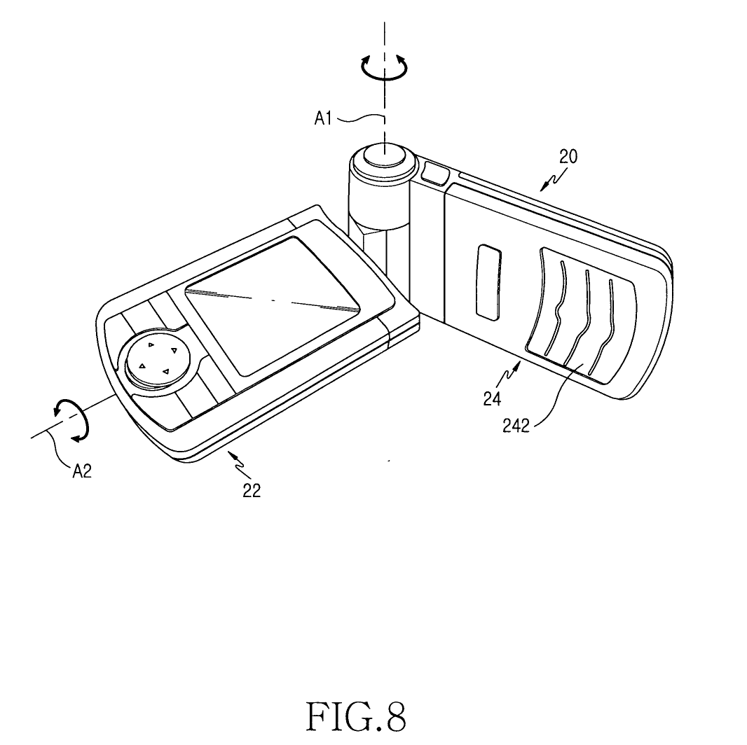

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein is omitted to avoid making the subject matter of the present invention unclear.

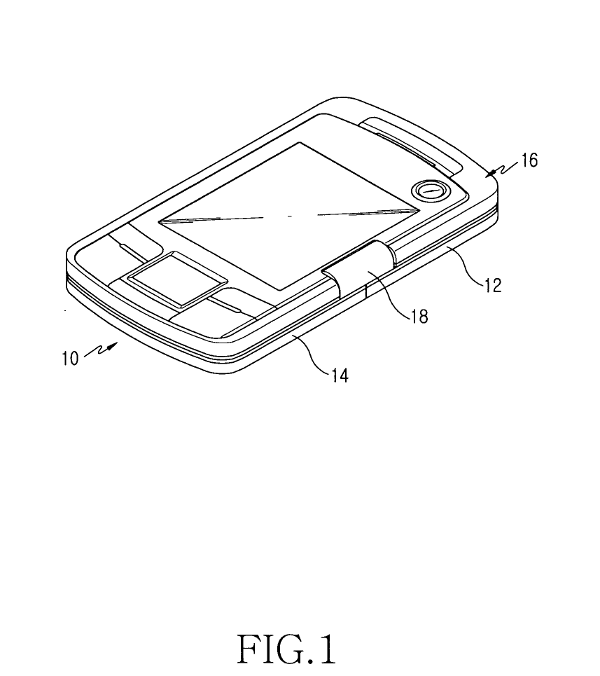

As shown in FIGS. 1, 2 and 4, a portable terminal according to the first preferred embodiment of the present invention includes a body 10, a display unit 16, a fixed keypad 12 and a movable keypad 14. The display unit 16 is connected to the body 10 through a swivel hinge unit 18 to open/close the upper surface of the body 10 or to be located parallel to the body 10 in the lengthwise direction of the body 10.

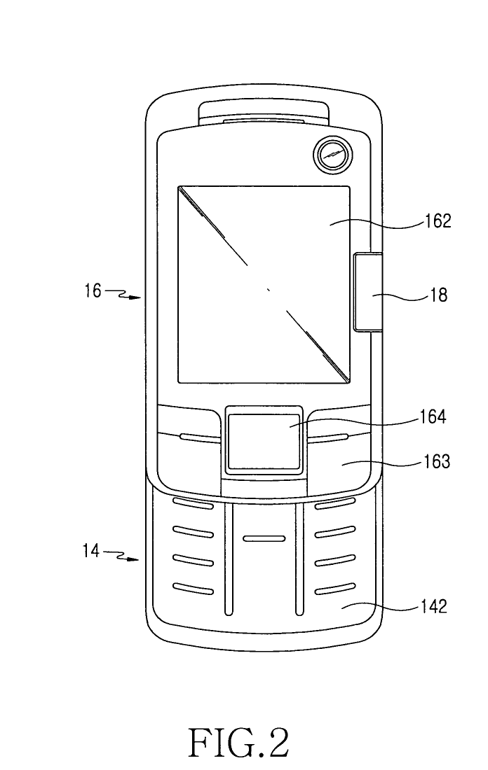

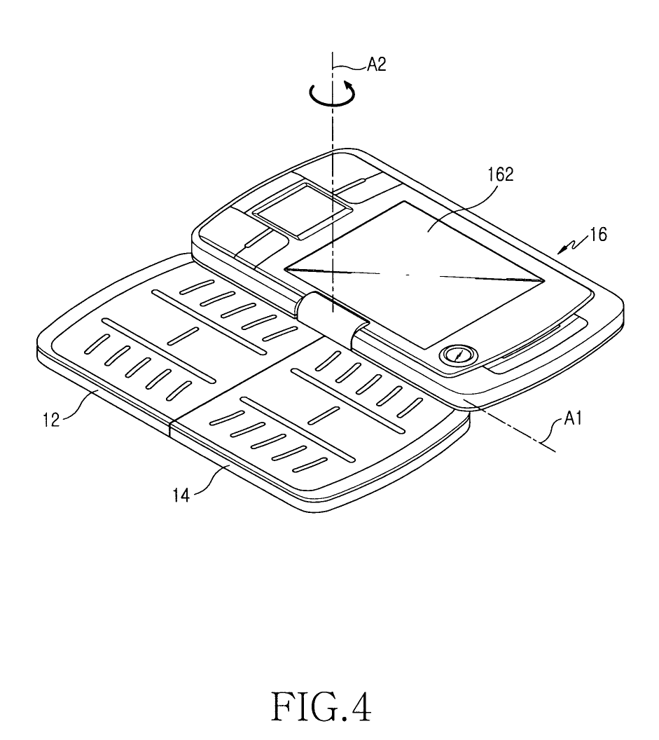

The fixed keypad 12 is fixed to one side of the body 10. The movable keypad 14 is moved so as to be close to or far away from the fixed keypad 12, facing the fixed keypad 12. Further, the movable keypad 14 is moved, facing the body 10, and is opened or closed by the rotation of the display unit 16 or the self-movement. FIG. 1 shows the closed state of the movable keypad 14. FIG. 2 shows the opened state of the movable keypad 14. FIG. 4 shows the state in which the movable keypad 14 is opened by the rotation of the display unit 16. Consequently, the movable keypad 14 slides from the body 10 into a usable state and can be used together with the fixed key pad 12 by the rotation of the display unit 16.

The fixed keypad 12 includes a first keypad 122 on which a plurality of keys are arranged, and the movable keypad 14 includes a second keypad 142 on which a plurality of keys are arranged. Preferably, the fixed keypad 12 and the movable keypad 14 together provide the QWERTY key arrangement which is convenient to input letters by using one or both hands of a user.

Then, the movable keypad 14 is operated by the slide movement and can be automatic, semi-automatic or manual. The movable keypad 14 is linearly moved from the body 10 to the lower side. The movable keypad 14 slides facing the display unit 16 continuously.

The display unit 16 opens or closes the fixed keypad 12 and the movable keypad 14 according to the rotation thereof. The completely opened state is shown in FIG. 4. Further, the display screen 162 is disposed on the upper surface of the display unit 16.

The swivel hinge unit 18 includes a rotary hinge unit providing first and second hinge axes A1 and A2 shown in FIG. 4. The first and second axes A1 and A2 are perpendicular to each other. The first hinge axis A1 is disposed on one side of the display unit 16 and the second hinge axis A2 is disposed in the middle of one side of the body 10. The first hinge axis A1 enables the display unit 16 to be folded and unfolded on the body 10 and the second hinge axis A2 disposes the display unit 16 parallel to the body 10 side by side. The second hinge axis A2 provides swing movement of the display unit 16. The swivel hinge unit 18 is disposed in the middle of one side of the body 10 or the display unit 16 to provide the state shown in FIG. 4.

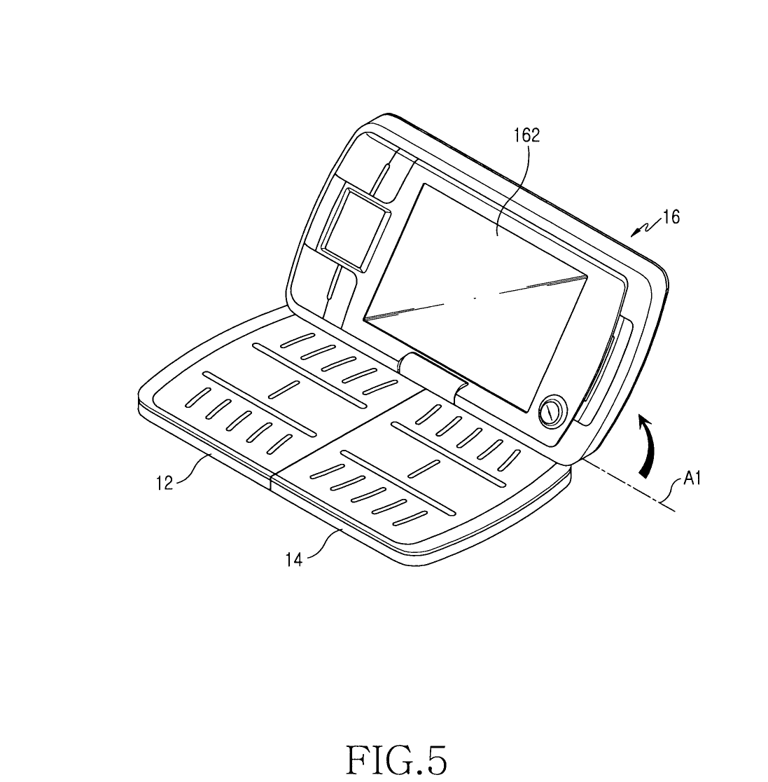

As shown in FIG. 5, the swivel hinge unit 18 installs the display unit 16 in an inclined manner from the body 10 by providing the display unit 16 with a predetermined driving force. A hinge module (not shown) for providing the first hinge axis A1 of the swivel hinge unit 18 includes a hinge spring, a hinge shaft and a hinge cam which are known in the art. Those skilled in the art will understand easily the structure in which the hinge module provides the opening/closing force of the display unit 16.

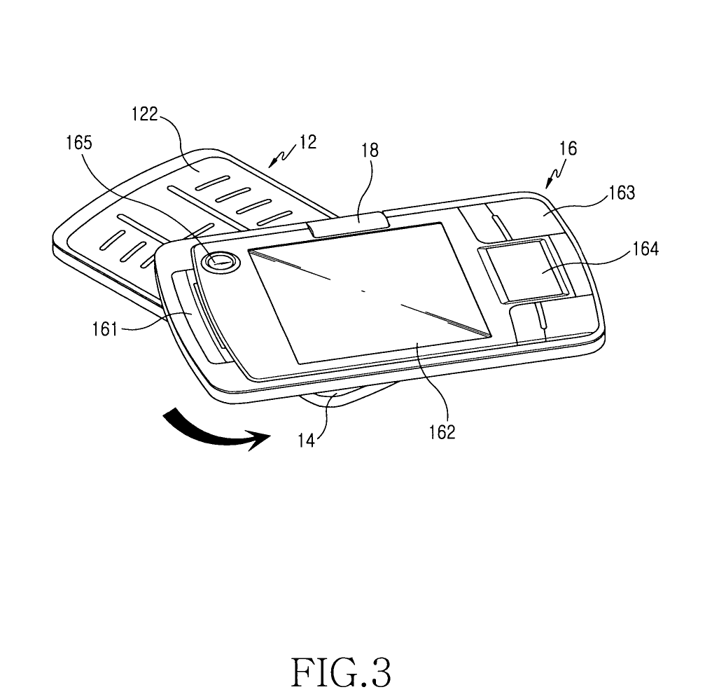

Additionally, as shown in FIG. 3, the portable terminal according to the present invention includes a speaker unit 161, a third keypad 163 in which a plurality of keys are arranged and a fingerprint recognition unit 164, at positions adjacent to the display unit 16.

In the position shown in FIG. 1, the talking mode can be used, the portable terminal can be conveniently used when called by a partner and the display unit 16 and the keys are used. In the position shown in FIG. 2, the portable terminal can be conveniently used when a user wants to dial the number and the display unit 16 and the movable key pad 14 are used. Further, in the position shown in FIG. 4 or FIG. 5, since the display unit 16 is in the landscape state, the portable terminal can be conveniently used in DMB mode, chatting mode, game mode, letter input mode and video phone mode. In particular, the data displayed on the display unit is conveniently seen, and since the fixed keypad 12 and the movable keypad 14 can be used together, a user may conveniently manipulate the keys with both hands.

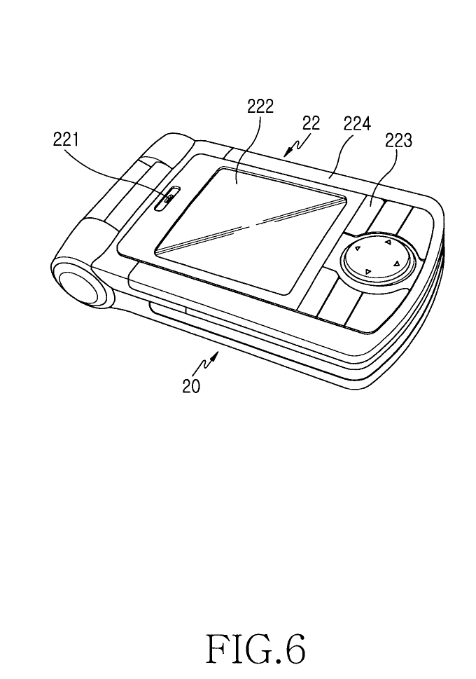

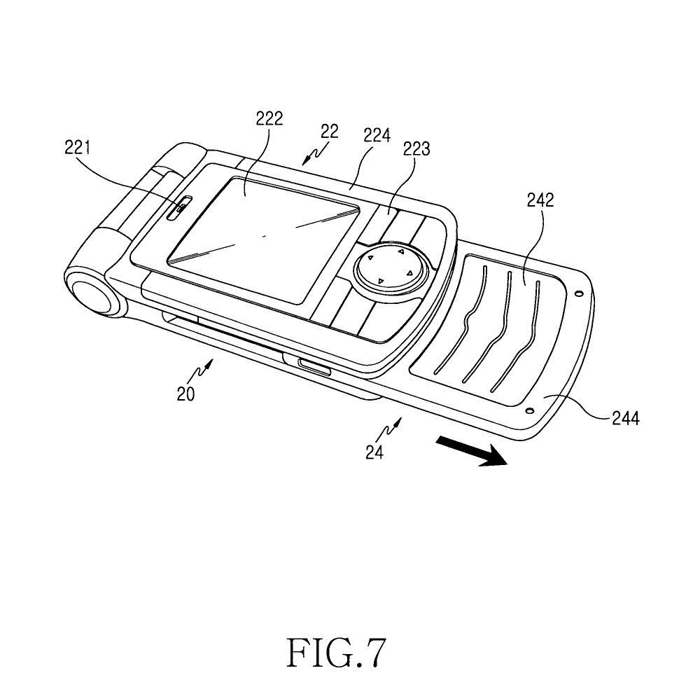

Referring to FIGS. 6 and 7, the shown portable terminal is a folder-type portable terminal according to a second preferred embodiment of the present invention. The portable terminal includes a body 20 and a folder 22 connected to the body 20 through a hinge unit to be folded or unfolded. The portable terminal includes the body 20, the folder 22 and a slide key pad 24. The slide keypad 24 is slidably mounted to the body 20 and slides in the lengthwise direction of the body 20, facing the body 20 continuously. The slide key pad 24 includes at least 3×4 keys 242 comprising number keys.

In the position shown in FIG. 6 in which the folder 20 is completely folded, the keypad 24 slides to be used as shown in FIG. 7. Specifically, the slide key pad 24 can be opened or closed according to the rotation of the folder 22 and the slide of the keypad 24 from the body 22. Preferably, the slide key pad 24 slides and used with the folder 22 closed.

The folder 22 can be rotated from the body 20 to be accommodated in the body 20 so that the upper and lower surfaces thereof are in reverse. The folder 22 can be rotated about the first hinge axis A1 and the second hinge axis A2 perpendicular to the first hinge axis A1. A speaker unit 221, a display unit 222 and a fixed keypad 223 including a plurality of keys are disposed on the upper surface of the folder 22.

In the position shown in FIG. 6, the body 20, the slide keypad 24, and the folder 22 are sequentially stacked, and in FIG. 7, the slide keypad 24 is adjacent to the fixed keypad 223 to be used.

As mentioned above, according to the present invention, since the slide keypad having at least 3×4 keys slides to be used in the closed state, a user can conveniently input data. According to the first preferred embodiment of the present invention, in letter input mode, keys can be conveniently manipulated with both of a user's hands by providing the QWERTY arrangement, and chatting mode, game mode and DMB mode can be conveniently performed with the landscape display unit.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable terminal comprising:
a body;
a display unit connected to the body through a swivel hinge unit to open and close an upper surface of the body or to be located parallel to the body along a lengthwise direction of the body;
a fixed keypad installed in the body; and
a movable keypad moved facing the body and so as to be close to or far away from the fixed keypad with the movable keypad facing the fixed keypad, and opened or closed by rotation of the display unit or self-movement,
wherein the movable keypad slides to be used even when the body is closed by the display unit, or the fixed keypad and the movable keypad are used together by the rotation of the display unit.

2. A portable terminal according to claim 1, wherein the movable keypad is slidably and linearly moved.

3. A portable terminal according to claim 1, wherein the swivel hinge unit includes a rotary hinge unit providing first and second hinge axes which are perpendicular to each other and are disposed in the middle of one side of the display unit.

4. A portable terminal according to claim 1, wherein the display unit is installed so as to be inclined by a drive source provided in the swivel hinge unit.

5. A portable terminal according to claim 1, wherein the fixed keypad includes a first keypad having at least three rows of four (3×4) keys, the movable keypad includes a second keypad having at least 3×4 keys, and the fixed keypad and the movable keypad provide a QWERTY key arrangement.

6. A portable terminal comprising:
a body;
a folder connected to the body through a hinge unit to be folded or unfolded; and
a slide keypad slidably moved with the slide keypad facing the body continuously for opening or closing an upper surface of the body according to a rotation of the folder or self-movement,
wherein the slide keypad is in a usable state by the slide thereof even when the folder is closed or by the rotation of the folder.

7. A portable terminal according to claim 6, wherein the folder is rotated so that upper and lower surfaces thereof can be in a reverse position, and a fixed keypad including a speaker unit, a display unit and a plurality of keys is disposed on the upper surface of the folder.

8. A portable terminal according to claim 7, wherein the fixed keypad and the slide keypad are adjacent to each other when the folder is closed on the body and the slide keypad slides.

9. A portable terminal according to claim 6, wherein the slide keypad includes at least three rows of four (3×4) keys comprising number keys.
